(19) United States
(12) Patent Application Publication
(10) Pub. No.: US 2025/0091486 A1
(43) Pub. Date: Mar. 20, 2025

(54) FUNCTIONAL UNIT FOR ADJUSTING A SEAT BACK OF A VEHICLE SEAT AND VEHICLE SEAT

(71) Applicant: Brose Fahrzeugteile SE & Co. Kommanditgesellschaft, Coburg, Coburg (DE)

(72) Inventors: Waldemar SCHRÖDER, Ahorn (DE); Johannes ULTSCH, Michelau i. OFr. (DE)

(21) Appl. No.: 18/964,926

(22) Filed: Dec. 2, 2024

Related U.S. Application Data
(63) Continuation of application No. PCT/EP2023/063930, filed on May 24, 2023.

(30) Foreign Application Priority Data
Jun. 1, 2022 (DE) 10 2022 205 627.2

(51) Int. Cl. B60N 2/20; B60N 2/02; B60N 2/90

(52) U.S. Cl. CPC B60N 2/20; B60N 2/02246; B60N 2002/924

(57) ABSTRACT

A functional unit adjusts a seat back of a vehicle seat and contains a functional support with an electrical pinion adjuster arranged thereon for moving the seat back, a blocking mechanism for blocking the backrest movement, and a seat adapter unit for securing to a seat substructure. The functional support has an upright bearing pin which forms a backrest rotational axis for the backrest movement together with the seat adapter unit. The blocking mechanism has a pawl system and a fixed blocking element. The pawl system is rotatably mounted on the functional support and has two blocking positions for blocking the backrest movement at opposing end sides of the blocking element. A rotatably mounted tooth segment is arranged on the bearing pin, which has a segment toothing engaged with the pinion adjuster and a protrusion. The blocking element has a recess for the tooth segment with two end-side stops.

### CROSS-REFERENCE TO RELATED APPLICATION

This application is a continuation, under 35 U.S.C. § 120, of copending International Patent Application PCT/EP2023/063930, filed May 24, 2023, which designated the United States; this application also claims the priority, under 35 U.S.C. § 119, of German Patent Application DE 10 2022 205 627.2, filed Jun. 1, 2022; the prior applications are herewith incorporated by reference in their entirety.

### FIELD AND BACKGROUND OF THE INVENTION

The invention relates to a functional unit for adjusting a seat back of a vehicle seat, having a functional support with an electric pinion adjuster arranged thereon for moving the seat back, and a blocking mechanism for blocking the seat back movement. The invention furthermore relates to a vehicle seat containing such a functional unit.

Vehicle seats in motor vehicles typically have seat backs or backrests which are embodied in such a way that they can be tilted or swiveled in order, for example, to change an inclination of the seat back. Particularly in the case of rear vehicle seats, e.g. rear seat benches, the seat back is movable into a substantially horizontal (load) surface position in order to provide a larger stowage surface in combination with a trunk volume. To prevent unwanted movement of the seat back (seat back movement), a blocking mechanism that inhibits, blocks or locks the seat back movement is generally provided here. To adjust or move the seat back, it is therefore typically necessary first of all to unlock the blocking mechanism.

In addition to purely mechanical adjustment systems, in which the seat back is unlocked manually by a vehicle user and, for example, moved against a preload on the seat back, electric adjustment systems are also possible, in which the adjustment is carried out, in particular, by electric motor. In the case of electric adjustment systems of this kind, the blocking mechanism is preferably likewise actuated electrically or by electric motor.

A diagrammatic structure of such an electric seat adjustment system is illustrated in FIGS. 1A and 1B and explained below. A vehicle seat 2 on which the electrification of a seat back 4 is implemented, for example, by means of a pinion adjuster (pinion drive) 6 additionally requires, at least in the upright or vertical operating position, a crash-proof and play-free lock in the form of a blocking mechanism 8.

In this case, the pinion adjuster 6 and the blocking mechanism 8 can be embodied, for example, as a common preassembly or delivery module in the form of a functional unit (functional module, seat adjustment module) 12. The functional unit 12 is positioned as a seat adjuster in the vicinity of the seat back rotational axis and connected in a fixed manner to the seat back 4 (or a seat back adapter). A seat adapter unit 14 provides a mechanical coupling of the functional unit 12 to a seat substructure 16 of the vehicle seat 2. In this case, the blocking mechanism 8 is typically equipped with a spring-loaded pawl system 18. During its movement, a drive pinion 20 of the pinion adjuster 6 rolls, with a corresponding transmission of power, on a tooth segment 22 and, with power-transmitting engagement of a pinion tooth system 24 of the drive pinion 20 with a segment tooth system 26 of the tooth segment 22, takes the seat back 4 along by means of the tooth segment 22. In this case, the tooth segment 22 and the seat adapter unit 14 are typically connected firmly or rigidly to one another.

For electric adjustment of the seat back 4 to a different fixed position (e.g. “load surface position”), it is necessary to unlock the blocking mechanism 8. For activation of the blocking mechanism 8, an additional electrified drive (actuator) 10 for the actuation of the pawl system 18 is provided, for example. The end of the unlocking or unblocking process is detected by a limit switch 12, wherein, following successful detection, the pinion adjuster 6 is activated for the seat back movement or tilting.

The applied functionalities of the blocking mechanism 8, in particular of the drive 10, disadvantageously take up additional installation space and increase the adjustment time and the structural weight and costs of the functional unit 12.

### SUMMARY OF THE INVENTION

It is the underlying object of the invention to specify a particularly suitable functional unit for adjusting a seat back of a vehicle seat. In particular, the intention is to ensure simple unlocking or unblocking of a blocking mechanism in a manner that is compact in terms of installation space. It is furthermore the underlying object of the invention to specify a particularly suitable vehicle seat comprising such a functional unit.

With the foregoing and other objects in view there is provided, in accordance with the invention, a functional unit for adjusting a seat back of a vehicle seat. The functional unit contains a functional support, an electric pinion adjuster disposed on the functional support for moving the seat back, and a blocking mechanism for blocking a seat back movement. The blocking mechanism has a spring-loaded pawl system and a fixed blocking element. The spring-loaded pawl system is pivotably mounted on the functional support and has two blocking positions for blocking the seat back movement at opposing end sides of the fixed blocking element. A seat adapter unit is provided for securing to a seat substructure. The functional support has an upright bearing journal, which forms a seat back rotational axis for the seat back movement together with the seat adapter unit. A pivotably mounted tooth segment is disposed on the upright bearing journal, and has a segment tooth system in engagement with the electric pinion adjuster and an extension. The fixed blocking element has a cutout formed therein and functions as a freewheel for the pivotably mounted tooth segment with two end-side stops. The extension engages in the cutout. A pivoting movement of the pivotably mounted tooth segment is blocked when the extension is in contact with one of the end-side stops.

According to the invention, the object is achieved in respect of the functional unit by the features of the independent functional unit claim and in respect of the vehicle seat by the features of the independent vehicle seat claim. Advantageous embodiments and further developments form the subject matter of the dependent claims. The advantages and embodiments presented in respect of the functional unit can also be applied mutatis mutandis to the vehicle seat and vice versa.

The functional unit according to the invention is provided for the adjustment or electrification of a seat back of a vehicle seat, and is suitable and configured for this purpose. In this case, the functional unit is embodied, for example, as a preassembled module or delivery module, i.e. as a seat adjustment module.

The functional unit has a functional support with an electric pinion adjuster arranged thereon as an adjusting drive for seat back movement of the seat back. In this context, a seat back movement (seat back adjustment) should be understood to mean, in particular, a swiveling or tilting movement of the seat back about a seat back rotational axis, which is typically arranged in a rear region of a seat part of the vehicle seat. The pinion adjuster has a drive pinion with a pinion tooth system, which can be driven by means of an electric motor.

The functional unit furthermore has a blocking mechanism for blocking, i.e. inhibiting or locking, the seat back movement. In this case, in particular, the blocking mechanism provides crash-proof and play-free blocking of the seat back movement in an operating location or operating position of the seat back.

The functional unit has a seat adapter unit, by means of which the functional unit can be secured or mounted on a seat substructure. In other words, the seat adapter unit forms a mechanical attachment point of the functional unit for mounting in a vehicle seat. This means that the seat adapter unit is embodied as an assembly interface between the functional unit and the seat substructure.

The functional support has an upright bearing journal, which forms the seat back rotational axis for the seat back movement together with the seat adapter unit.

The blocking mechanism has a spring-loaded pawl system and a blocking element that is fixed, i.e. is rigid or incapable of (relative) movement. The pawl system is pivotably mounted on the functional support, e.g. by means of a (second) bearing journal. The blocking element has two opposite end sides, wherein the end sides provide two blocking positions of the blocking mechanism, in which the pawl system blocks a seat back movement.

According to the invention, a pivotably mounted tooth segment is arranged on the bearing journal forming the seat back rotational axis. In this case, the tooth segment has a segment tooth system which is in an operative or driving connection with the pinion adjuster, in particular with the pinion tooth system. In particular, the segment tooth system is in mechanical or meshing engagement with the pinion adjuster or pinion tooth system thereof.

The tooth segment furthermore has an extension. According to the invention, it is furthermore envisaged that the blocking element has a cutout as a freewheel or idle travel sector for the tooth segment, in which cutout the extension engages. The cutout, which is also referred to below as a freewheel cutout, has two end-side stops as end positions for the extension, which is guided in such a way that it can be swiveled between the stops in the freewheel cutout by virtue of the pivotable mounting of the tooth segment. The stops are each arranged adjacent to the blocking positions. In this case, the pivoting movement of the tooth segment is blocked when the extension is in contact or makes stop contact with one of the stops. In other words, the tooth segment is pivotable only in the swiveling range—formed between the stops—of the freewheel cutout (freewheel sector).

In contrast to the prior art, the tooth segment is not connected in a fixed manner to the seat substructure or the seat adapter unit but is mounted pivotably on the seat back rotational axis or bearing journal. The tooth segment can thus be pivoted or rotated relative to the seat adapter unit. According to the invention, the tooth segment thus has the possibility of pivoting freely in the freewheel range or idle travel sector of the cutout. A free travel movement of the tooth segment is thereby made possible, and this can be used to activate the blocking mechanism. In this context, a free travel movement of the tooth segment should be understood to mean, in particular, a movement of the tooth segment during which there is no seat back movement. By means of the free travel movement, a tooth segment movement that can be used to actuate or unlock the blocking mechanism is ensured. In other words, the freewheeling of the blocking element enables activation or actuation of the blocking mechanism, thus ensuring release (unblocking, unlocking) of the blocking mechanism, even without an additional drive. A particularly suitable functional unit is thereby achieved; in particular, the functional unit is thus embodied in a way which is particularly compact in terms of installation space and reduces the weight of the structure since a separate drive for actuating the blocking mechanism can be omitted.

In the installed or assembled state, the functional unit and thus the blocking mechanism are arranged on a seat back side. The opposite seat back side of the seat back is preferably embodied with a similar blocking mechanism. The blocking mechanisms of the two seat back sides are coupled, for example, via a Bowden cable. The Bowden cable is coupled to the pawl system of the functional unit on the active seat back side, i.e. the seat back side having said functional unit. The two blocking mechanisms thus operate synchronously.

In an advantageous embodiment, the extension is in contact in each of the blocking positions of the pawl system with the opposing stop of the freewheel. This ensures that play-free and crash-proof locking or blocking of the seat back movement is ensured despite the freewheel. In other words, the seat back can be locked without play in the end stop by means of the pawl system.

Thus, the blocking element has, for example, an upper blocking position for the pawl system (on the upper blocking element end side) and an upper stop for the extension (on the upper cutout end side) as well as a lower blocking position for the pawl system and a lower stop for the extension. In this context, the terms “upper” and “lower” refer, in particular, to the relative location with respect to the blocking element, irrespective of the actual position in the surrounding space. For example, the extension is at an upper stop when the pawl system is in a lower blocking position and vice versa.

In a suitable development, the extension moves within the freewheel cutout from one stop to the other when the pinion adjuster performs a driving movement to move the seat back. In the course of the driving movement, the pinion adjuster drives the drive pinion in rotation, causing the pinion tooth system to run in the segment tooth system. The tooth segment, which meshes with the pinion tooth system via the segment tooth system, is thus swiveled, as a result of which the extension is swiveled in the freewheel cutout. When the extension is moved from an end position formed by the stops into an intermediate position situated in between, the pawl system is moved out of a blocking position into an intermediate position that releases the seat back movement. The functional unit is therefore embodied in such a way that the pinion adjuster activates the tooth segment in such a way that the pawl system is activated to unlock the blocking mechanism by the movement of the extension within the idle travel.

After the extension makes stop contact with the respective other stop and is thus in the opposite end position, the seat back movement takes place in that the drive pinion rolls on the now fixed tooth segment. By means of the stop, a connection, in particular a positive and/or nonpositive connection, is thus formed between the tooth segment and the fixed blocking element. The tilting or swiveling process of the seat back movement should end in a mechanical stop and should advantageously also be blocked. In the further development, this function is also performed by the blocking mechanism. During the seat back movement, the pawl system is transferred to the respective other blocking position, with the pawl system being released at the end of the seat back movement, with the result that it moves into the corresponding blocking position of the fixed blocking element on account of the spring preload, and the seat back is thus blocked in its seat back position. The unlocking of the blocking mechanism and the seat back movement are thus controlled by means of a common driving movement of the pinion adjuster, thereby shortening the adjustment time of the seat back.

Here and below, the conjunction “and/or” should be understood in such a way that the features linked by means of this conjunction can be formed jointly or as alternatives to one another.

Here and below, “positive engagement” or a “positive connection” between at least two interconnected parts is understood, in particular, to mean that the interconnected parts are held together at least in one direction by direct interlocking of contours of the parts themselves or by indirect interlocking via an additional connecting part. The “blocking” of movement relative to one another in this direction is therefore dependent on shape.

Here and below, “nonpositive engagement” or a “nonpositive connection” between at least two interconnected parts is understood, in particular, to mean that the interconnected parts are prevented from sliding off one another by means of a frictional force acting between them. If a “connecting force” (this means the force that presses the parts together, e.g. the force of a screw or gravity itself) causing this frictional force is absent, the nonpositive connection cannot be maintained and is thus released.

An additional or further aspect of the invention envisages that the tooth segment has a link part for guiding (activating, actuating) the pawl system between the blocking positions. Reliable and secure guidance of the pawl system is thereby achieved. In particular, the link part ensures that the pawl system remains open during the seat back movement. Here, the link part preloads the pawl system or the spring(s) thereof.

At the edge, the link part has, for example, a convex link contour, along which the pawl system is guided into the intermediate positions in the manner of a sliding block between the blocking positions.

In this context, a convexly curved link contour should be understood to mean a surface that is arched outward. In this case, the surface of a body is convex if a straight line between arbitrarily selectable points on this surface runs completely within the body. In this case, other areas of the surface should be ignored.

In an expedient embodiment, the blocking element is arranged on the seat adapter unit. In the installed state, the seat adapter unit is joined in a fixed manner to a seat substructure, thereby ensuring that the blocking element is arranged reliably and securely in a fixed location, i.e. is fixed with respect to the substructure. Particularly stable and operationally reliable blocking of the seat back movement in the blocking positions of the pawl system is thereby ensured.

In one conceivable embodiment, the pawl system has two separate pawls and a coupling driver. In this case, the pawls are each preloaded by means of a spring element. The spring elements are embodied, for example, as leg springs (torsion springs) with two spring legs and a spiral or coiled spring body arranged in between, wherein, for example, in each case one of the spring legs is fixed on the seat adapter part and the other is fixed on the associated pawl. The coupling driver is directly guided by means of one of the pawls, for example. During the seat back movement, the coupling driver slides, in the manner of a sliding block for example, along the link part of the tooth segment. In other words, there is an interaction between the link part and the pawl system, in particular via the coupling driver.

In a suitable further development, the coupling driver is coupled to a Bowden cable. In other words, the coupling driver has a point of coupling or attachment to a Bowden cable. In this case, the Bowden cable is designed, in particular to ensure the travel of the blocking mechanism on the opposite seat back side. During the unlocking process, the pawl that is not guided directly by means of the coupling driver is also taken along by the coupling driver after a short travel.

In a preferred design, the functional unit has a seat back adapter. The seat back adapter is provided, suitable and configured for securing the functional support on the seat back. The seat back adapter thus forms the attachment or assembly interface between the functional unit and the seat back.

In an expedient development, the functional unit has an electronic unit, which is arranged on the functional support. In this case, the electronic unit monitors a blocking state of the blocking mechanism by means of a state detector. In other words, the electronic unit detects whether the pawl system is in one of the blocking positions or blocking states. The electronic unit has, for example, a control unit for the electric-motor pinion adjuster. Reliable and secure electric seat back adjustment or seat back movement is thereby ensured. The electronic unit thus detects the crash-proof state of the blocking mechanism. The state detector is embodied as a microswitch, for example.

The vehicle seat according to the invention is provided, suitable and configured for a motor vehicle. The vehicle seat is embodied as a driver seat or front passenger seat, for example. In particular, the vehicle seat is embodied as a rear seat or as a rear seat bench.

In this case, the vehicle seat has a seat part as a seat surface with a seat substructure, which is connected in a fixed manner to a vehicle body in the installed state. The vehicle seat furthermore has a seat back articulated swivelably on the seat part as well as an above-described functional unit for the electric or electric-motor adjustment of the seat back. A particularly suitable vehicle seat is thereby obtained.

Other features which are considered as characteristic for the invention are set forth in the appended claims.

Although the invention is illustrated and described herein as embodied in a functional unit for adjusting a seat back of a vehicle seat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is a diagrammatic, perspective view of a vehicle seat having an electrified seat back according to the prior art;

FIG. 1B is a perspective view of a functional unit of the vehicle seat according to the prior art;

FIG. 2 is a schematic illustration of a vehicle seat containing a seat back and a functional unit according to the invention;

FIG. 3 is a perspective view of a detail of the functional unit;

FIG. 4 is an exploded, perspective view of the functional unit;

FIG. 5 is a perspective view of a tooth segment of the functional unit;

FIG. 6 is a block view of a blocking element of the functional unit;

FIGS. 7 to 9 are illustrations of the functional unit during a movement of the seat back in successive illustrations.

In all the figures, mutually corresponding parts and dimensions are provided with the same reference signs.

### DETAILED DESCRIPTION OF THE INVENTION

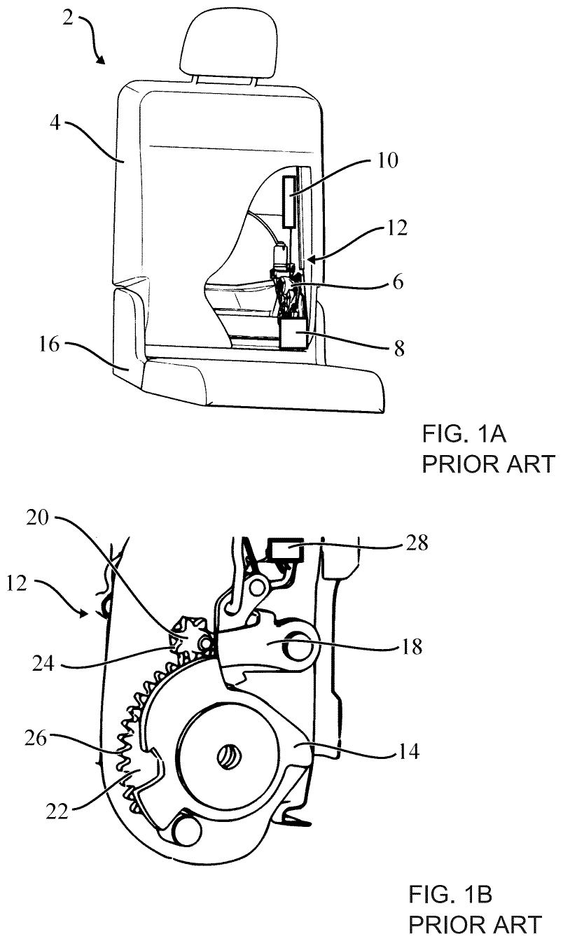

Referring now to the figures of the drawings in detail and first, particularly to FIG. 1 thereof, there is shown a vehicle seat 30 comprising a seat part 32 and an electrified seat back 34 in a simplified and schematic illustration. In this case, the seat part 32 has a seat surface 36 and a seat substructure (seat support) 38, for example. In the assembled state, the seat substructure 38 is connected in a fixed manner to a vehicle body. The vehicle seat 30 is a rear seat or a rear seat bench of a motor vehicle, for example.

For electrification of the seat back 34, the vehicle seat 30 has a functional unit 40 as an actuating device. The functional unit 40 has a drive or servomotor in the form of a pinion adjuster 42, which acts by means of a drive pinion 44 on an actuating mechanism 46 of the seat back 34. The actuating mechanism 46 has a tooth segment 48 and a blocking mechanism 50 with a blocking element 52 and with a pawl system 54.

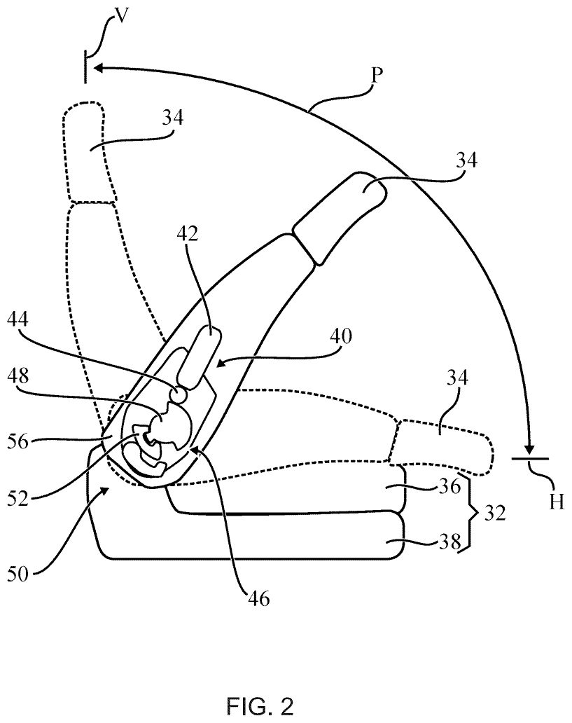

When the pinion adjuster 42 is actuated, the seat back 34 is moved in its (seat back) position P (seat back movement). In this case, the seat back 34 can be moved reversibly between an approximately vertical operating position V, which forms the highest possible position P, and an approximately horizontal operating position (load surface position) H, which forms the lowest possible position P. In these positions V and H, the seat back 34 is in each case indicated in dashed lines in FIG. 2. In contrast, the seat back 34 is illustrated by solid lines in a half-inclined intermediate position. In positions V and H, the seat back 34 is locked or blocked by means of the blocking position 50.

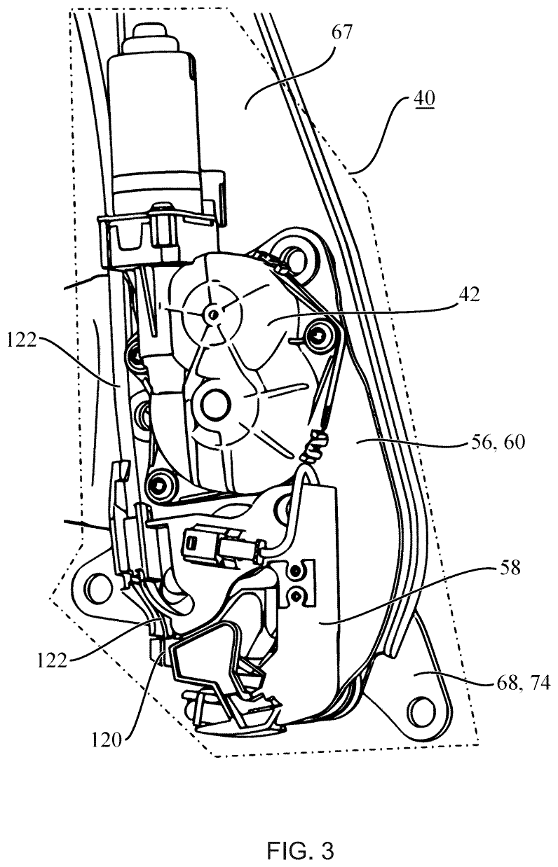

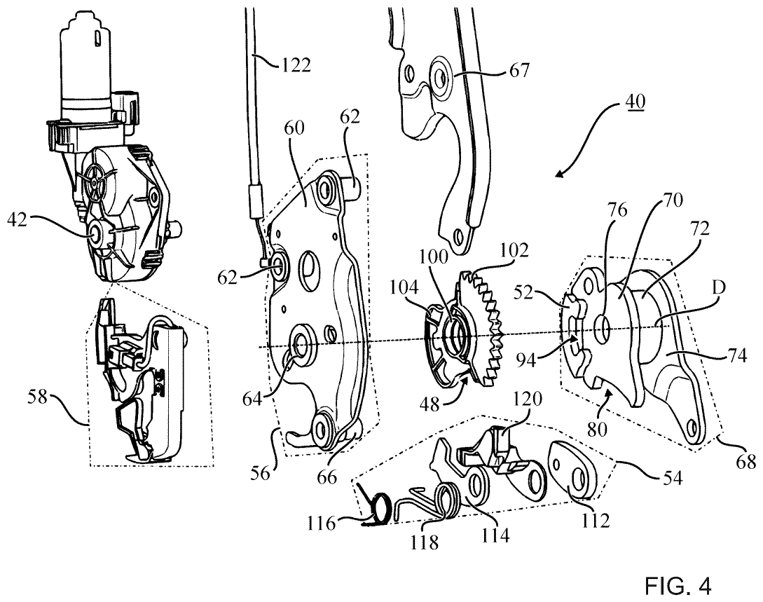

The construction and functioning of the functional unit 40 will be explained in more detail below with reference to FIGS. 3 to 9.

The functional unit 40 is embodied as a preassembled or delivery module (seat adjustment module). In this case, the functional unit 40 has a functional support 56, on which the pinion adjuster 42, the adjusting mechanism 46 and an electronic unit 58 are arranged.

The functional support 56 has a base plate 60 with connecting elements 62 for securing the components supported on the functional support 56. In this case, the connecting elements 62 are provided with reference signs purely by way of example. The base plate 60 has two upright bearing journals (bearing pins) 64, 66, by means of which the tooth segment 48 and the pawl system 54 are pivotably or rotatably mounted. In this case, the bearing journal 66 forms a seat back rotational axis D for the seat back movement.

The functional unit 40 has a seat back adapter 67 as an attachment or assembly interface with the seat back 34, the adapter being joined rigidly to the functional support 56 or base plate 60.

For attachment or mounting on the seat substructure 38, the functional unit 40 has a seat adapter unit 68. The seat adapter unit 68 has three connecting parts 70, 72, 74, by means of which a fixed connection to the seat substructure 38 is implemented. The blocking element 52 is secured on connecting part 70. The blocking element 52 is thus arranged on the seat adapter unit 68 in a fixed manner, i.e. rigidly or in a manner fixed with respect to the substructure.

Connecting part 70 together with the blocking element 52 is illustrated separately in FIG. 6. In this case, connecting part 70 has at least two holes 76, 78. The approximately central hole 76 is oriented coaxially with the seat back rotational axis D and forms an attachment point with the bearing journal 64. The hole 78 forms a receptacle for springing of the seat back 34, for example.

On a lower edge facing the seat substructure 38, connecting part 70 has a recess 80, which is bounded essentially by a set-back inner edge of concave design. In this case, the inner edge on the one hand forms a seat back stop 82 during operation, by means of which force dissipation is implemented during a rear crash event. Opposite the seat back stop 82, the inner edge furthermore forms a contour 84 for force dissipation in the event of a frontal crash event.

Connecting part 70 can have, for example, a further recess 86, which is arranged below the blocking element 52. The recess 86 is illustrated in dashed lines in FIG. 6. The recess 86 has an inner edge, which forms a seat back stop 88 for a load surface.

The blocking element 52 is embodied as a stop segment. In this case, the blocking element 52 has a shape which is approximately that of a circular ring segment. The blocking element 52 has two outer end sides 90, 92, which form blocking positions S1, S2 for the pawl system 54. In this case, end side 90 furthermore ensures play compensation in the load surface (operating position H), wherein end side 92 allows play compensation during operation (operating position V). A (freewheel) cutout 94 approximately in the form of a circular segment is introduced into the blocking element 52 on the concave inner side. The cutout 94 has a stop 96, which is arranged adjacent to end side 90, and a stop 98, which is arranged adjacent to end side 92, the stops being formed by the inner contour of the cutout 94.

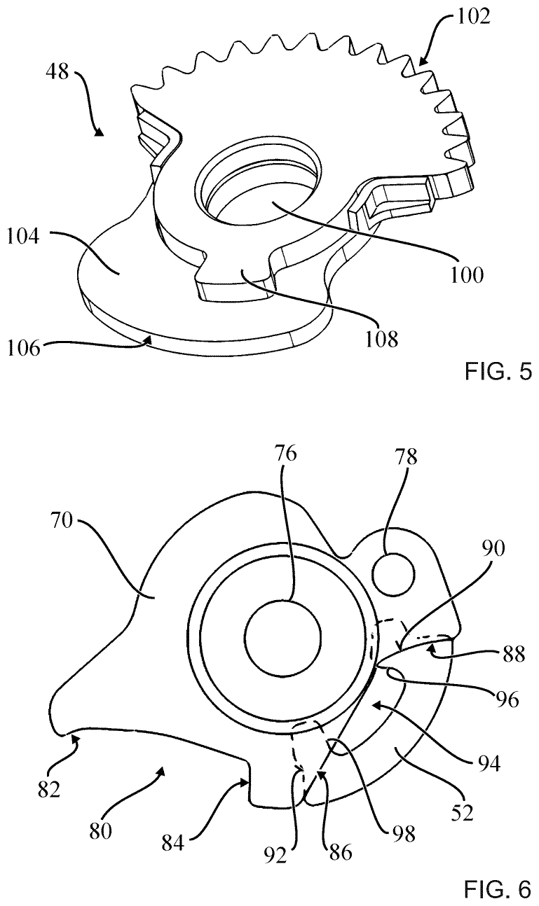

The tooth segment 48 is arranged on bearing journal 64 in such a way as to be pivotable or rotatable between the functional support 56 and the seat adapter unit 68. The tooth segment 48, which is shown in isolation in FIG. 5, has a central through opening 100 to receive bearing journal 64. The tooth segment 48 is not connected in a fixed manner to the seat substructure 38 or the seat adapter unit 68 but is mounted pivotably on the seat back rotational axis D or bearing journal 64. The tooth segment 48 can thus be pivoted or rotated relative to the seat adapter unit 68.

The tooth segment 48 furthermore has a toothed side and an oppositely situated link side. The toothed side, which is approximately in the form of a quarter-circle segment, has a segment tooth system 102 on the rim or circumference. The link side approximately in the form of a quarter-circle segment is formed by a link part (link attachment) 104. The link part 104 has a convex link contour or link surface 106 on the rim or circumference for activating the pawl system 54.

The tooth segment 48 furthermore has an integrally formed extension 108, which rises from a flat side of the link part 104, running in an orientation approximately radial with respect to the through opening 100. In the assembled state, the extension 108 engages at least partly in the freewheel cutout 94. In this case, the freewheel cutout 94 acts as a freewheel or idle travel sector for the tooth segment 48. In this case, the pivoting movement of the tooth segment 48 is blocked when the extension 108 is in contact with one of the stops 96, 98. The tooth segment 48 thus has the possibility of pivoting freely in the freewheel range or idle travel sector of the freewheel cutout 94. The link part 104 and the extension 108 as well as the segment tooth system 102 form a single component for conjoint rotation. In other words, the tooth segment 48 does not have any moving parts.

In the assembled state, the segment tooth system 102 is in meshing engagement with a pinion tooth system 110 of the drive pinion 44.

The blocking mechanism 50 is provided, suitable and configured for blocking, i.e. inhibiting or locking, the seat back movement. In this case, in particular, the blocking mechanism 50 provides crash-proof and play-free blocking of the seat back movement in the operating locations or operating positions V, H of the seat back 34. The blocking mechanism 50 has the spring-loaded pawl system 54 and the fixed blocking element 52 on the seat adapter unit 68. The pawl system 54 is mounted pivotably on the bearing journal 66 of the functional support 56.

The pawl system 54 has two pawl parts or pawls 112, 114, wherein pawl part 112 ensures the crash-proof retention of the seat, and pawl part 114 ensures the play-free retention thereof. Both pawls 112, 114 are preloaded separately by spring elements 116, 118. In this case, pawl 112 is preloaded by means of spring element 116, and pawl 114 is preloaded by means of spring element 118. In addition, the pawl system 54 is equipped with a coupling driver 120, which is sandwiched between the pawls 112, 114.

The spring elements 116, 118 are embodied, for example, as leg springs (torsion springs) with two spring legs and a spiral or coiled spring body arranged in between. In the assembled state, the spring bodies are mounted on bearing journal 66. In this case, the pawls 112, 114 and the coupling driver 120 each have a through opening, by means of which the components are mounted on bearing journal 66.

The coupling driver 120 is directly guided by pawl 112. It is via the coupling driver 120 that the interaction with the link part 104 or link surface 106 is accomplished.

In the installed or assembled state, the functional unit 40 and thus the blocking mechanism 50 are arranged on a seat back side of the seat back 34. The opposite seat back side of the seat back 34 is preferably embodied with a similar blocking mechanism. The blocking mechanisms of the two seat back sides are coupled, for example, via a Bowden cable 122. The Bowden cable 122 is coupled to the pawl system 54 of the functional unit 40 on the active seat back side, i.e. the seat back side having said functional unit. In particular, the coupling driver 120 has a point of coupling to the Bowden cable 122 to ensure the travel of the blocking mechanism 50 on the opposite seat back side. Upon unlocking, pawl 114 is also taken along after a short travel of the coupling driver 120.

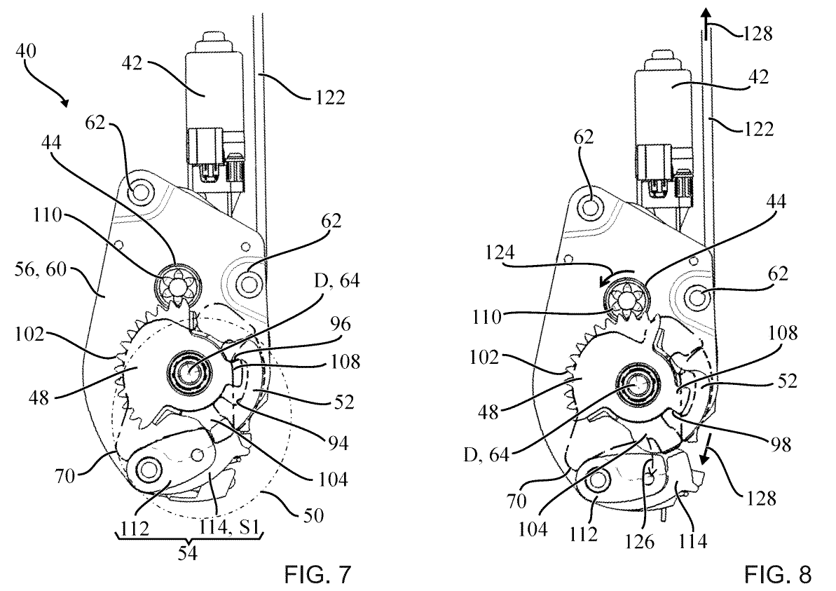

A seat back movement from operating position V to operating position H of the seat back 34 by means of the functional unit 40 is explained in greater detail below with reference to FIGS. 7 to 9.

Here, FIG. 7 shows the functional unit 40 in a mode of the seat back 34 in which the seat back 34 is situated in operating position V. The seat back 34 is in an end stop position and is locked without play by the pawl system 54. Here, the end stop position is provided by stop contact between the link part 104 and the end side of pawl 112 or the coupling driver 120. Here, pawl 114 is in a blocking position S1 in contact with the end side 92 of the blocking element 52. The extension 108 is in contact with stop 96.

FIG. 8 shows the functional unit 40 at the start of the seat back movement, in which the pinion adjuster 42 or drive pinion 44 performs a short driving movement 124. The driving movement 124 is indicated by means of an arrow in FIG. 8. The tooth segment 48 is driven by the driving movement 124, wherein the tooth segment 48 pivots on account of the freewheel or idle travel sector formed by the freewheel cutout 94. During this process, the extension 108 is swiveled from stop 96 to stop 98.

During this swiveling movement, the link part 104 is also swiveled, wherein the coupling driver 120 is guided on the link surface 106. By virtue of the movement of the coupling driver 120, the directly guided pawl 112 is taken along, producing a travel 126 which releases pawl 114 from blocking position S1. By means of the interaction of the link part 104 with the pawl system 54, the pawl system 54 is thus released from the locked state (locking position S1), and the spring elements 116 and 118 are put under stress. During this process, there is furthermore an actuation 128 of the Bowden cable 122, which transmits the unlocking travel to the other seat back side. The travel 126 and the actuation 128 are shown as arrows in FIG. 8.

As soon as the extension 108 is at stop 98, there is a nonpositive and/or positive connection between the tooth segment 48 and the blocking element 52, which locks or blocks any further pivoting movement of the tooth segment 48. The tooth segment 48 is thus held in a manner fixed against rotation on the blocking element 52 or seat adapter unit 68. After unlocking, the tilting or swiveling movement of the seat back 34 begins, wherein, on account of the driving movement 124 of the drive pinion 44, it rolls over the segment tooth system 102 of the tooth segment 48. During this process, the pawl system 54 remains open, wherein the coupling driver 116 slides along the link surface 106. The pawl system 54 is thus held back with unlocking effect by the link surface 106.

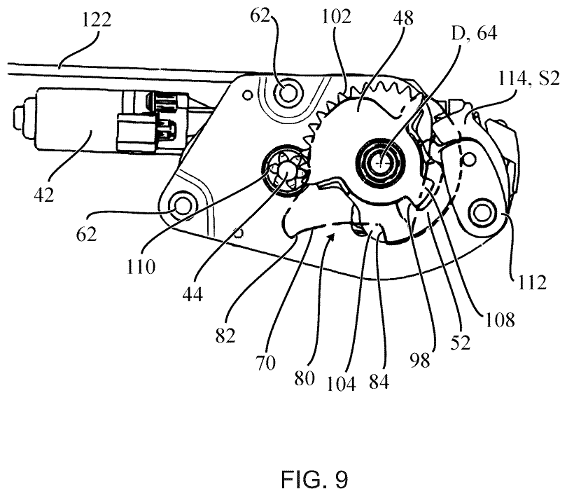

FIG. 9 shows the functional unit 40 at the end of the seat back movement when the seat back 34 has been swiveled into operating position H. At the end of the swiveling movement, the coupling driver 120 is at the opposite link surface end of the link surface 106, as a result of which the pawl system 54 is released again. By means of the spring load of the spring elements 116, 118, the pawls 112, 144 are moved back. During this process, pawl 112 latches in on the seat back stop 88 of the connecting part 70, wherein pawl 114 is moved into the blocking position S2 on end side 90.

During a seat back movement from operating position H into operating position V, the unlocking of the blocking mechanism 50 and the tilting of the seat back 34 takes place in a corresponding manner in a reverse sequence, wherein the extension 108 swivels from stop 98 to stop 96, and the pawl system 54 is moved along the link surface 106 from the blocking position S2 to blocking position S1.

The blocking positions S1, S2 or the blocking or locking state of the blocking mechanism 50 is monitored by means of a state detector, e.g. by means of a microswitch, of the electronic unit 58.

The claimed invention is not restricted to the exemplary embodiments described above. On the contrary, other variants of the invention can also be derived therefrom within the scope of the disclosed claims by a person skilled in the art without departing from the subject matter of the claimed invention. In particular, all the individual features described in connection with the various exemplary embodiments can also be combined with one another in some other way within the scope of the disclosed claims without departing from the subject matter of the claimed invention.

The following is a summary list of reference numerals and the corresponding structure used in the above description of the invention:
2 vehicle seat
4 seat back
6 pinion adjuster
8 blocking mechanism
10 drive
12 functional unit
14 seat adapter device
16 seat substructure
18 pawl system
20 drive pinion
22 tooth segment
24 pinion tooth system
26 segment tooth system
28 limit switch
30 vehicle seat
32 seat part
34 seat back
36 seat surface
38 seat substructure
40 functional unit
42 pinion adjuster
44 drive pinion
46 actuating mechanism
48 tooth segment
50 blocking mechanism
52 blocking element
54 pawl system
56 functional support
58 electronic unit
60 base plate
62 connecting element
64,66 bearing journal
67 seat back adapter
68 seat adapter unit
70, 72, 74 connecting part
76,78 hole
80 recess
82 seat back stop
84 contour
86 recess
88 seat back stop
90, 92 end side
94 cutout
96, 98 stop
100 through opening
102 segment tooth system
104 link part
106 link surface
108 extension
110 pinion tooth system
112, 114 pawl
116, 118 spring element
120 coupling driver
122 Bowden cable
124 driving movement
126 travel
128 actuation
P seat back position
V, H operating position
S1, S2 locking position
D seat back rotational axis

1. A functional unit for adjusting a seat back of a vehicle seat, the functional unit comprising:
a functional support;
an electric pinion adjuster disposed on said functional support for moving the seat back;
a blocking mechanism for blocking a seat back movement, wherein said blocking mechanism has a spring-loaded pawl system and a fixed blocking element, wherein said spring-loaded pawl system is pivotably mounted on said functional support and has two blocking positions for blocking the seat back movement at opposing end sides of said fixed blocking element;
a seat adapter unit for securing to a seat substructure, wherein said functional support has an upright bearing journal, which forms a seat back rotational axis for the seat back movement together with said seat adapter unit;
a pivotably mounted tooth segment disposed on said upright bearing journal, and having a segment tooth system in engagement with said electric pinion adjuster and an extension;
said fixed blocking element has a cutout formed therein and functions as a freewheel for said pivotably mounted tooth segment with two end-side stops, wherein said extension engages in said cutout; and
a pivoting movement of said pivotably mounted tooth segment is blocked when said extension is in contact with one of said end-side stops.

2. The functional unit according to claim 1, wherein in the blocking positions of said spring-loaded pawl system, said extension is in contact with a respective one of said end-side stops situated opposite thereto.

3. The functional unit according to claim 1, wherein during a driving movement of said electric pinion adjuster, said extension moves within said cutout from one of said end-side stops to another one of said ends-side stops, and during the driving movement, said spring-loaded pawl system is moved out of a blocking position into an intermediate position that releases the seat back movement.

4. The functional unit according to claim 1, wherein said pivotably mounted tooth segment has a link part for guiding said spring-loaded pawl system between the blocking positions.

5. The functional unit according to claim 1, wherein said fixed blocking element is disposed on said seat adapter unit.

6. The functional unit according to claim 1, wherein said spring-loaded pawl system has two separate pawls and a coupling driver, wherein said two separate pawls are each preloaded by means of a spring element.

7. The functional unit according to claim 6, further comprising a Bowden cable, said coupling driver is coupled to said Bowden cable.

8. The functional unit according to claim 1, further comprising a seat back adapter for securing on the seat back is secured on said functional support.

9. The functional unit according to claim 1, further comprising an electronic unit having a state detector, said electronic unit disposed on said functional support, said electronic unit monitoring a blocking state of said blocking mechanism by means of said state detector.

10. A vehicle seat, comprising:
a seat part having a seat substructure;
a seat back swivelably articulated on said seat part; and
said functional unit according to claim 1.
